(19) United States
(12) Patent Application Publication
(10) Pub. No.: US 2019/0015754 A1
(43) Pub. Date: Jan. 17, 2019

(54) Apparatus, computer-readable storage medium storing an application thereon, system and method

(71) Applicant: THEODOR RADU, DES PLAINES, IL (US)

(72) Inventor: THEODOR RADU, DES PLAINES, IL (US)

(21) Appl. No.: 15/650,941

(22) Filed: Jul. 16, 2017

(51) Int. Cl. A63F 13/92; H04B 1/12

(52) U.S. Cl. CPC A63F 13/92; A63F 13/30; H04B 1/126

(57) ABSTRACT

A system comprises a plurality of apparatuses. A method is enabled by a plurality of apparatuses. A computer-readable storage medium stores an application thereon. An apparatus transmits first data and receives first data transmitted by another apparatus, then in response to receiving first data, transmits second data to a plurality of apparatuses and receives second data transmitted by any of the plurality of apparatuses. The apparatus which transmitted or received first data attains objectives of an application. A plurality of apparatuses which received second data obtain information about attained objectives of the application. The apparatus, the system, the method or the computer-readable storage medium are each usable to play an interactive game when the application is a game application.

### FIELD OF THE INVENTION

The present invention is concerned with an apparatus, computer-readable storage medium storing an application thereon, system and method. In particular, but not in exclusivity, the present invention is concerned with an apparatus, computer-readable storage medium storing an application thereon, system and method, for providing an interactive game.

### DESCRIPTION OF RELATED ART

A large number of computer games, console games, arcade games, virtual reality games, and other games and entertainment systems enabled by computer processors exist on the market today and aim to provide entertainment to game players. Though these games have some entertainment value, however they have two significant drawbacks. The first drawback is that the physical activity connected with the game play, that is while engaging in the game-playing activities, is limited. Traditional computer games are played in front of a computer screen, video screens, TV screens, game consoles and other video output devices. Prolonged game play, devoid of physical activity, is detrimental to the players' health. The second drawback is that the game play involves little or no in-person interaction between players, therefore prolonged game play deprives the players of essential social interaction skills. Prior art has tried to address these drawbacks; however prior art has only offered partial solutions to these drawbacks, for example limited game functionality.

Many computer-enabled games in prior art have attempted to address these drawbacks. There are many computer games that advertise their interactive capabilities; however the “interaction” in these prior art is not in-person interaction as part of the game play, rather it is generally “interaction” of the players' in-game characters with each other within the virtual game environment, not interaction of the game players in real life. In these games, each player plays individually by interacting with their own game controller. Language is used in these games that appear to indicate interaction between players, such as the players “found”, “met”, “tagged”, “shot” each other, however these actions are in-game actions of the players' characters, whereas the game players themselves may never meet each other in person, and they may be located in different locations, cities, even countries as the engage in the game play. Certain games provide for limited interaction such as instant messaging, audio or video communication with each other in the game play. However, these are no substitute for in-person interaction. Therefore, these games do not provide a solution to the drawbacks of limited physical activity and limited in-person interaction within the game play.

Other computer-enabled games in prior art have further attempted to address these drawbacks. Certain computer games were able to integrate limited physical activity and player physical proximity within the game play. Examples of these games are activity-specific games such as dance games in which the players perform dance moves mimicking the dance moves shown on a video display device; computer-enabled golf games in which the player uses a physical golf club and physical golf ball and practices golf skills by shooting into a screen simulating a golf course; and other activity-specific games. Physical activity in these games is limited to the specific activity of the game play and it is confined to the close proximity of the video display device. For example, computer-enabled dance games are played by all players in the same room and watching the same video display device to mimic the movements of the on-screen character; golf simulator games are played in front of the video display device simulating an image of a golf course. Therefore, the physical activity in these games is limited to an enclosed and limited location in close proximity of the video display device. In addition, though the players are in close physical proximity to each other, in-person interaction within the game play is limited as the players do not primarily interact with each other as part of the game play, rather each player interacts primarily with a game console. Players may be in close physical proximity to other players, such as if multiple players gather in the same room and their game controllers are connected to the same game console. They may have some in-person interaction by virtue of being in close physical proximity, however the in-person interaction is primarily outside of the game play itself rather than as part of the game play. Therefore, these games do not provide a solution to the drawback of limited in-person interaction within the game play.

Other computer-enabled games in prior art have further attempted to address these drawbacks. Examples are games played within a confined game arena, for example indoor lager tag or indoor themed computer-enabled games, for example wizardry-themed games which use a dedicated indoor game physical environment or arena. In these games the players' physical activity is confined to a larger space than the games mentioned above. In indoor laser tag, the players interact in-person in a confined physical location which is limited by the placement of sensors through the game arena and the communicable range of central servers which process the game software. In indoor themed games, the players interact primarily with physical objects which correspond with in-game virtual characters and objects. The physical objects are located throughout a confined game arena defined by the placement of sensors or game pieces and by the communicable range of central servers which process the game software. Though these game arenas can be of large size, such as covering a number of floors in a building, they are still confined to a limited indoors location.

Significant logistics would be involved in moving the location or changing the physical set up of the game arena due to the need to relocate the physical objects which correspond to virtual characters and objects, the game sensors and the central servers. Therefore, these games do not provide a solution to the drawback of limited physical activity; and some of these games also do not provide a solution to the drawback of limited in-person interaction within the game play. In addition, these games introduce an additional drawback, namely the high cost of setting up or moving game arenas.

Other computer-enabled games in prior art have further attempted to address these drawbacks. Examples are outdoor laser tag games. Some of these games are located within confined outdoors arenas; and some of these games can be portable. Outdoor laser tag games located within pre-set arenas are essentially similar to indoor laser tag games. They have the same drawbacks as indoor laser tag games, namely that the game arena is limited by the placement of sensors through the game arena and the communicable range of central servers which process the game software; and that they introduce an additional drawback, namely the high cost of setting up or moving game arenas. Portable laser tag games are modified from indoor laser tag games. These games incorporate physical activity and in-person interaction between players, however in order to allow for these capabilities, these games had to limit essential game features. Sensors are no longer pre-set in a confined game arena; and a computer server can no longer be connected in real time to the game controllers. Therefore, due to the lack of a central server to execute the game software and the controller's own very limited processing capabilities, the games have limited functionality which limits the entertainment value of the game. These games allow for role plays, and they allow each player to obtain real-time status updates about their own in-game activities, but they do not allow for real-time status updates about all of the other player's in-game activities. Therefore, while portable laser tag games incorporate physical activity and in-person interaction within the game play, they introduce an additional drawback, namely the limited functionality such as inability to obtain real-time updates about all player's in-game activities; and this limited functionality reduces the entertainment value of the game.

Other computer-enabled games in prior art have further attempted to address these drawbacks. Such games are portable game consoles, which can easily be portable to any location. However, portable game consoles are not primarily in-person interactive games; rather the primary interaction is still between a player's in-game character and other in-game characters or objects. Therefore, these games do not provide solutions to the drawbacks of limited physical activity and limited in-person interaction within the game play.

Other computer-enabled games in prior art have further attempted to address these drawbacks. Examples are complimentary devices with limited functionality which cannot enable the game play by themselves, but rather are used as complimentary devices to the processing power of another device such as a smartphone, tablet, or other similar device. Examples are games of tag enabled by a device connected to a smartphone. In these games, the controller is connected to a player's smartphone, therefore the game play is dependent on the processing capability of the smartphone's processor. The game play is physically active and involves in-person interaction between players, and the players receive real-time updates on their smart phone about the in-game activities of each player. However, these games introduce an additional drawback, namely that that smartphones with real-time data connectivity are needed in order to play the game. Therefore, while these games incorporate physical activity and in-person interaction within the game play, they introduce additional drawbacks, namely the incremental needed cost of owning a smartphone; that game play is not available to players who do not own a smartphone; and that game play is not available in areas or at times without data connectivity.

Despite all the advances in the art, the drawbacks of limited physical activity and limited in-person interaction within the game between players still persist in the prior art. Prior advancements in the art has attempted to solve this problem, however it has been able to address it only partially or at the expense of introducing other significant drawbacks such as high cost or limited game functionality. Therefore, the drawbacks were not fully solved.

Embodiments of the present invention solve the above-mentioned drawbacks without introducing the other significant drawbacks introduced by prior art. The game play enabled by the present invention is physically active, which helps strengthen the player's physical condition, and it is in-person interactive between game players, which provides for a more entertaining game play and strengthens social bonds between players. In embodiments of the current invention, each central processing unit is capable of processing or executing the game software. Therefore, the need for a central server is eliminated and the game play is no longer confined to the physical proximity of a game server. In addition, each central processing unit is programmable, allowing for role play, including the roles of game players or game objects, therefore eliminating the need for dedicated game objects placed in a game arena. In addition, embodiments of the current invention provide for full communication capabilities between players, allowing each player to receive real-time updates about the in-game activities of all other players. In addition, embodiments of the current invention are not dependent on the processing power of a smartphone or other complementary device, rather embodiments of the current invention have the processing power which enables the game play. In addition, embodiments of the present invention are portable to any location and they are inexpensive, affordable for the mainstream player.

Embodiments of the present invention are a novel way, not previously envisioned, of solving the above-mentioned drawbacks of the prior art. Different embodiments of the present invention may solve all or a number of the above-mentioned drawbacks.

Therefore embodiments of the present invention are much more than just an improvement in the prior art; they are a complete paradigm shift in the art of computer processing enabled games.

### BRIEF SUMMARY OF THE INVENTION

An object of the present invention is to provide an apparatus, computer-readable storage medium storing an application thereon, system and method.

In one aspect of the present invention, an apparatus includes communication means and processing means. The communication means comprises first communication circuitry and second communication circuitry. The communication means includes transmitting means and receiving means. The transmitting means of the first communication circuitry transmits, by wireless communication, first data to at least one other apparatus. The receiving means of the first communication circuitry receives, by wireless communication, first data that was transmitted from the transmitting means of the first communication circuitry of another apparatus. The transmitting means of the second communication circuitry transmits second data, by wireless communication, to a plurality of apparatuses. The receiving means of the second communication circuitry receives, by wireless communication, second data that was transmitted from the transmitting means of the second communication circuitry of any of the plurality of apparatuses. Examples of first communication circuitry include, but are not limited to, infrared communication circuitry capable of communicating via infrared signals for example utilizing a frequency of approximately 38 kHz or other frequencies for example approximately between 30 kHz to 56 kHz; or other wireless communication circuitry capable of communicating via wireless signals. Examples of second communication circuitry include, but are not limited to, radio communication circuitry capable of communicating via radio signals for example frequencies which do not require a radio license; or Wi-Fi communication circuitry capable of communicating via Wi-Fi signals for example in conformity with the IEEE802.11 standard, including the base standard and any amendment or a plurality of amendments of the base standard; or other wireless communication circuitry capable of communicating via wireless signals.

The processing means performs processes of an application by using first data and performs processes of an application by using second data. The processes performed using first data may differ from the processes performed using second data. Examples of processes performed using first data include, but are not limited to, processes to attain objectives of the application. Alternatively, information contained within second data includes information contained within first data, and examples of processes performed using the second data include, but are not limited to, processes to attain objectives of the application. Examples of processes performed using second data include, but are not limited to, processes to obtain information about attained objectives of the application. The processing means comprises information processing circuitry. Examples of information processing circuitry include, but are not limited to, one or a plurality of computer processors, or one or a plurality of central processing units, or other components with similar functionality.

The apparatus may further comprise storing means, capable of storing the application thereon. The storing means comprises computer-readable storage medium. Examples of computer-readable storage mediums include, but are not limited to, volatile memory for example RAM or PSRAM or non-volatile memory for example flash memory, memory card, memory cartridge, ROM, hard drive, solid state drive, EPROM, or other components with similar functionality.

In one aspect of the present invention, a computer-readable storage medium stores an application thereon, wherein the application causes a central processing unit of an apparatus to perform operations including: receiving, via first communication means, first data transmitted by the central processing unit of another apparatus; receiving, via second communication means, second data transmitted by the central processing unit of any of a plurality of apparatuses; performing processes of the application by using the first data or second data to attain objectives of the application; and performing processes of the application by using the second data to obtain information about attained objectives of the application.

In one aspect of the present invention, a system includes communication means and processing means. The communication means comprises first communication circuitry capable of performing first wireless communication and second communication circuitry capable of performing second wireless communication. The first communication circuitry transmits first data through first wireless communication from a transmitting information processing device to a receiving information processing device. The second communication circuitry automatically transmits second data through second wireless communication from the receiving information processing device (as determined by reference to the first wireless communication) to a plurality of information processing devices. The processing means comprises information processing circuitry and it is configured to cause the first communication circuitry to perform the first wireless communication and to cause the second communication circuitry to perform the second wireless communication. The processing means is further configured to perform predetermined processes of an application by using the first data; and to perform predetermined processes of the application by using the second data. The system may further include storage means. The storage means comprises computer-readable storage medium capable of storing the application thereon.

In one aspect of the present invention, a method enabled by a plurality of information processing devices, includes the sub-processes of: transmitting first data via first communication means; receiving first data transmitted via the first communication means; transmitting second data via second communication means in response to receiving first data; receiving second data transmitted via the second communication means; performing, by processing means, processes of an application by using the first data; and performing, by processing means, processes of the application by using second data.

In certain aspects of the present invention, the application of the present invention may be any of a wide variety of programs, wherein each program contains instructions executable by processing means, including one or more computer processors or central processing units. The apparatus, computer-readable storage medium storing an application thereon, system and method are each usable for executing processes of the application. The program may be any of a wide variety of games. Examples of games include but are not limited to, king of the hill, protect the VIP, capture the flag, deathmatch games, domination games, treasure or scavenger hunt games, racing games, themed games for example chivalry, wizardry, western, civilization or culture themed games, games of tag, and other games.

In certain aspects, the present invention enables socially interactive game play, in which the players' physical persons may interact with each other through game activities in direct physical proximity to each other, as opposed to traditional computer games in which a player's in-game character interacts with other players' in-game characters.

In certain aspects, the present invention enables physically active game play, with the intensity of activity depending on the game being played. Players may engage in various physical activities depending on the game being played, for example running, walking, jumping, sprinting, hiding, ducking, climbing, obstacle course scampering, mud running and other physical activities which are useful to play a game.

In certain aspects, the present invention enables customizable game play in a wide variety of physical settings such as a playfield, a backyard, an athletic field, a themed building, a residence, a forest preserve, a national park, in the city or village center, on neighborhood streets, or another suitable location. The present invention enables game play with or without having connectivity to a network, for example the internet. For example the application may be pre-loaded on the computer-readable storage medium of an apparatus, therefore having no need to have or maintain internet connectivity and may be played in physical locations without internet connectivity. Conversely, the application may be downloaded from a network, for example the internet or cloud storage, therefore having no need for a computer-readable storage medium of large capacity. Aspects of the present invention enable customizable game play of a wide variety of game applications, or customization of an application for example customization of game parameters including rules, objectives, assigned roles, powers or other game parameters.

In certain aspects of the present invention, routing means comprising routing circuitry is usable to route wireless communication transmitted by an apparatus or information processing device. An example of routing circuitry includes, but is not limited to, Wi-Fi router operating in the approximately 2.4 GHz or 5 GHz frequencies. The routing means is usable to enlarge the geographic area over which wireless communication signals may be transmitted and received, therefore it is capable of enlarging the geographic area over which a game may be played.

In certain aspects of the present invention, amplification means comprising amplification circuitry is usable to amplify wireless communication performed by a plurality of apparatuses. An example of amplification circuitry is Wi-Fi antenna capable of transmitting and receiving communication signals at a signal gain between for example zero to 20 dBi (decibels). The communication circuitry may comprise the amplification circuitry. The amplification means is usable to enlarge the geographic area over which wireless communication signals may be transmitted and received by the plurality of apparatuses, therefore it is capable of enlarging the geographic area over which a game may be played.

In certain aspects of the present invention, centralization means is usable to reduce the number of communication signals transmitted and received within the game play between the plurality of apparatuses, thus reducing the latency of the communication between the plurality of apparatuses. An example of centralization means is an apparatus configured to centralize wireless communication between apparatuses.

In certain aspects of the present invention, an apparatus may be configured to centralize performing processes of the application.

In certain aspects of the present invention, audio transmission and reception means, or video transmission and reception means, or both may be used by the game players.

Audio transmission and reception communication means comprise audio circuitry. Examples of audio circuitry include, but are not limited to, microphones, speakers, headsets. Video transmission and reception communication means comprise video circuitry. Examples of video circuitry include, but are not limited to, photo cameras, video cameras, video displays. The audio or video communication means are usable to enable the players to communicate in additional ways. The audio or video communication means may be configured in multiple ways, for example such that solely players with certain assigned in-game roles, for example players on the same team, may be able to communicate with each other through the audio or video communication means. For example, players on the same team may use headsets to communicate about a broad range of topics, for example to strategize their next offensive or defensive in-game activities, or even to joke, laugh, and have a good time discussing in-game activities. As another example, players on the same team may use video communication means to communicate to each other their physical location, for example by taking and transmitting a picture or a video, without causing noise such as when using audio communication means, which could be overheard by players on the competing team.

In certain aspects of the present invention, predetermined components of an apparatus or of an information processing device are accommodated on or within a housing which may be portable by a player.

The detailed description taken in conjunction with the accompanying drawings provide further description of aspects of the present invention.

### BRIEF DESCRIPTION OF THE SEVERAL VIEWS OF THE DRAWING

FIG. 1 is a block diagram showing an example of the internal configuration of an apparatus 1.

FIG. 2A is a block diagram showing another example of the internal configuration of an apparatus 1.

FIG. 2B is a block diagram showing an example of the internal configuration of a printed circuit board 10.

FIG. 3A is a diagram showing an example of an in-application action.

FIG. 3B is a diagram showing an example of in-application updates.

FIG. 4 is a diagram showing an example of transmission and reception of wireless communication signals via routing circuitry 11.

FIG. 5 is a diagram showing an example of apparatus 1S performing amplification and centralization of wireless communication signals.

FIG. 6A is a diagram showing an example of first data 15.

FIG. 6B is a diagram showing an example of second data 16.

FIG. 7 is a flowchart showing an example of apparatuses 1 performing sub-processes of an application.

FIG. 8 is a diagram showing an example of the CPU 2 processing an assignment of a role to an apparatus 1.

FIG. 9 is a diagram showing an example of a “king of the hill” game in accordance with an embodiment of the present invention.

FIG. 10A is a diagram showing an example of the video circuitry 7 outputting a graphical representation of an in-game activity.

FIG. 10B is a diagram showing an example of the video circuitry 7 outputting a graphical representation of game parameters and game state.

### DETAILED DESCRIPTION OF THE INVENTION

The objectives and advantages of the present invention will be realized or attained by means of the elements and combinations particularly pointed out in the claims. It is to be understood that both the foregoing summary of the invention and the following detailed description of the invention are exemplary and explanatory and are not restrictive or limiting of the present invention.

An embodiment of the present invention is a non-limiting example of an embodiment applied as an apparatus which is an information processing device (hereinafter referred to as “apparatus”) 1.

Another embodiment of the present invention is a non-limiting example of an embodiment applied as a non-volatile computer-readable storage medium, exemplified in a non-limiting way by the first non-volatile memory 5.

Another embodiment of the present invention is a non-limiting example of an embodiment applied as a system comprising a plurality of information processing devices.

Another embodiment of the present invention is a non-limiting example of an embodiment applied as a method enabled by providing a plurality of information processing devices.

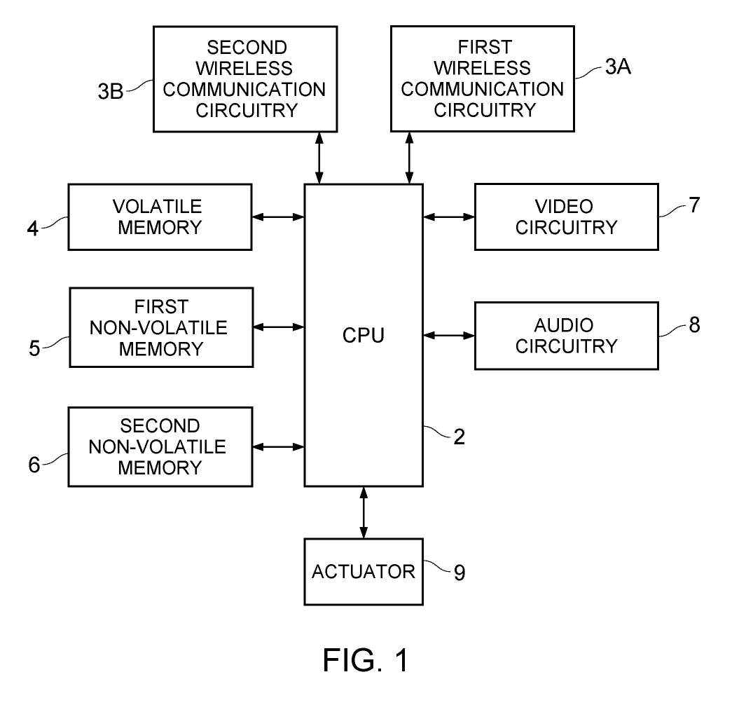

FIG. 1 is a block diagram showing a non-limiting example of the internal configuration of an apparatus 1 according to an embodiment of the present invention. The apparatus 1 is information processing device.

In this example embodiment, apparatus 1 comprises the components: a central processing unit which is information processing circuitry (hereinafter referred to as “CPU”) 2, first wireless communication circuitry 3A which is communication circuitry, second wireless communication circuitry 3B which is communication circuitry, volatile computer-readable storage medium (hereinafter referred to as “volatile memory”) 4, non-volatile computer-readable storage medium (hereinafter referred to as “first non-volatile memory”) 5, non-volatile computer-readable storage medium (hereinafter referred to as “second non-volatile memory”) 6, video circuitry 7, audio circuitry 8 and actuator 9, or components with similar functionality. The first wireless communication circuitry 3A, second wireless communication circuitry 3B, volatile memory 4, first non- volatile memory 5, second non-volatile memory 6, video circuitry 7, audio circuitry 8 and actuator 9 are in communicative connection with the CPU 2 through any suitable connections which are well understood by one skilled in the art.

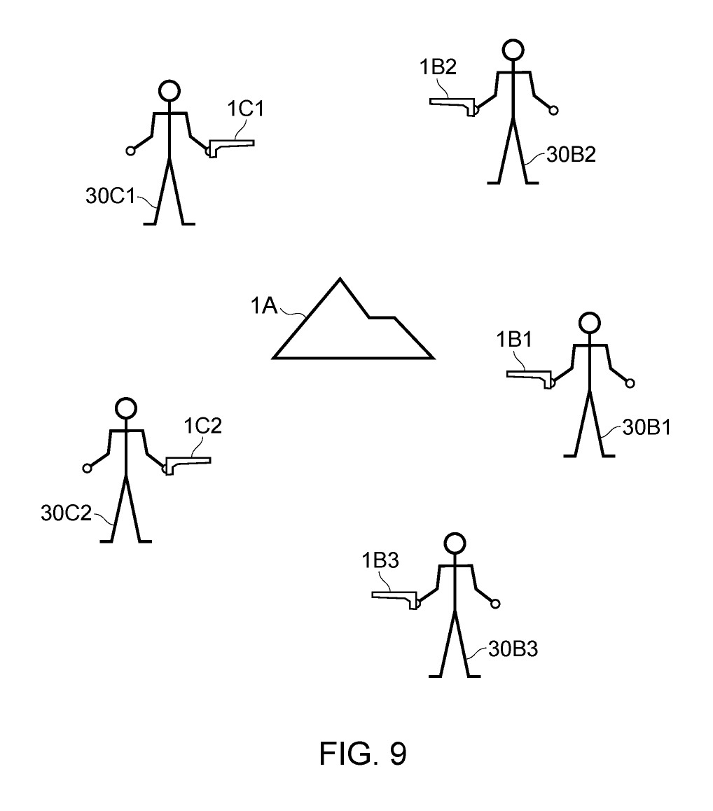

The CPU 2 of this example embodiment is information processing circuitry capable of executing predetermined applications of the present invention, including the non-limiting example application described by reference to FIG. 9 as well as other applications including the non-limiting example game applications described further below.

The first wireless communication circuitry 3A of an apparatus 1 of this example embodiment is capable of performing wireless communication with the first wireless communication circuitry 3A of another apparatus 1.

The first wireless communication circuitry 3A is capable of transmitting one or more first data to the first wireless communication circuitry 3A of another apparatus 1, and receiving one or more first data from the wireless communication circuitry 3A of another apparatus 1, through wireless communication. The CPU 2 is capable of transmitting first data to the CPU 2 of another apparatus 1 and receiving first data from the CPU 2 of another apparatus 1 through the wireless communication performed by the wireless communication circuitry 3A of the apparatus 1 transmitting the first data with the wireless communication circuitry 3A of the apparatus 1 receiving the first data.

A non-limiting example of first wireless communication circuitry 3A is infrared (hereinafter referred to as “IR”) communication circuitry which is capable of performing wireless communication which is IR communication by transmitting and receiving one or more IR signals, to another wireless communication circuitry 3A located within reachable IR signal communication distance.

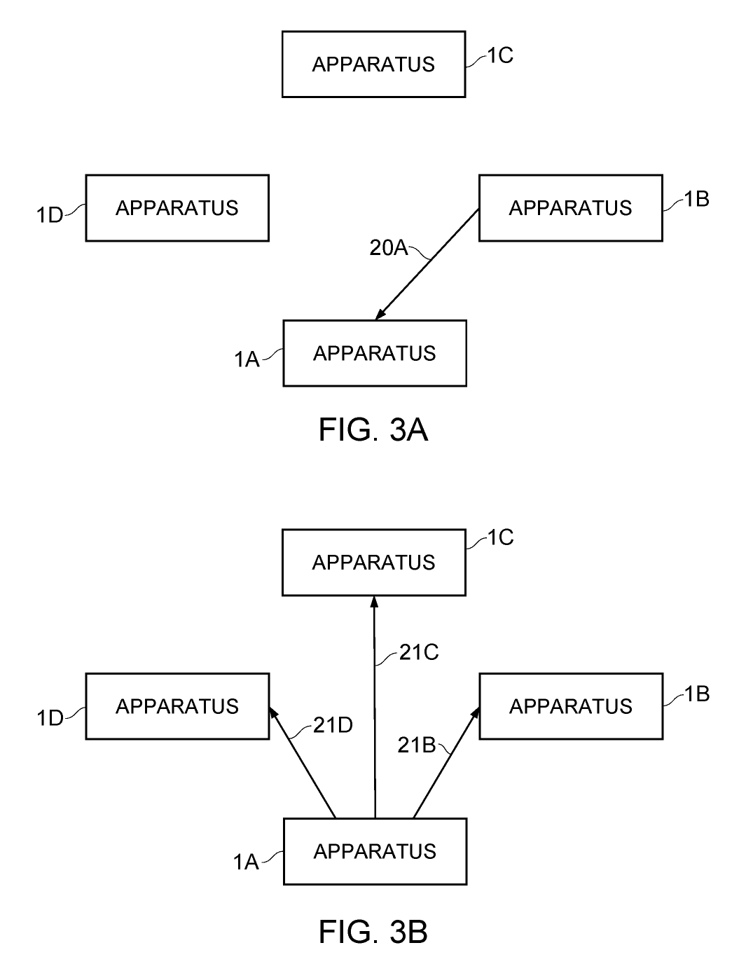

IR communication may utilize a frequency of approximately 38 kHz (kilohertz), or other IR frequencies for example approximately between 30 kHz to 56 kHz, or other IR frequencies. The wireless communication circuitry 3A may transmit and receive first data via the IR communication. Transmitting and receiving first data is exemplified by reference to FIG. 3A. Examples of first wireless communication circuitry 3A are: IR transceiver or both IR transmitter and IR receiver. Examples of IR transmitter are one or more IR LED (light-emitting diode). Examples of IR receiver are one or more IR sensors. The first wireless communication circuitry 3A may, but is not required to, perform IR communication through a cone (not shown) in order to focus the IR signal into a narrow angle which will enable it to transmit IR signals to the first wireless communication circuitry 3A of another apparatus located within that narrow angle. The first wireless communication circuitry 3A may, but is not required to, transmit the IR signals without the use of a cone, into a wider angle, which will enable it to transmit IR signals to the wireless communication circuitry 3A of any apparatuses located within that wide angle. The IR receiver may be positioned in relation to the apparatus or worn by the user such that IR signals transmitted by IR transmitter of other apparatuses may be received over a wide angle, for example close to 360 degrees.

An “in-application action” occurs when a transmitting apparatus 1 transmits first data 15 by its first wireless communication circuitry 3A and a receiving apparatus 1 receives the first data 15 by its first wireless communication circuitry 3A. An “in-application action” is wireless communication performed by the first wireless communication circuitry 3A of the transmitting apparatus 1 with the first wireless communication circuitry 3A of the receiving apparatus 1. When the application is a game application, the “in-application action” is hereinafter called “in-game action”.

The second wireless communication circuitry 3B of this example embodiment is capable of performing wireless communication with the second wireless communication circuitry 3B of another apparatus 1. The second wireless communication circuitry 3B is capable of transmitting one or more second data to the wireless communication circuitry 3B of another apparatus, and receiving one or more second data from the wireless communication circuitry 3B of another apparatus, through wireless communication. The CPU 2 is capable of transmitting second data to the CPU 2 of another apparatus 1 and receiving second data from the CPU 2 of another apparatus 1 through the wireless communication performed by the wireless communication circuitry 3B of the apparatus transmitting the second data with the wireless communication circuitry 3B of the apparatus receiving the second data.

A non-limiting example of second wireless communication circuitry is radio circuitry, for example Wi-Fi circuitry which is capable of performing wireless communication which is Wi-Fi communication for example by transmitting and receiving one or more Wi-Fi signals through a local area network (LAN), for example in conformity with the IEEE802.11 standard, including the base standard and any amendment or a plurality of amendments of the base standard, or another standard in the unlicensed radio frequency spectrum. The second wireless communication circuitry 3B is capable of performing Wi-Fi communication by transmitting and receiving one or more Wi-Fi signals to another wireless communication circuitry 3B located within reachable Wi-Fi signal communication distance. The wireless communication circuitry 3B may transmit and receive second data via the Wi-Fi communication. Transmitting and receiving second data is exemplified by reference to FIG. 3B and FIG. 4 and FIG. 5. Examples of second wireless communication circuitry 3B are: Wi-Fi transceiver and Wi-Fi antenna or all of Wi-Fi transmitter and Wi-Fi receiver and Wi-Fi antenna. The Wi-Fi antenna can have a gain of for example 0 (zero) to 9 dBi (decibels) or for more gain 9 to 20 bDi, or another gain.

The apparatus 1 may be associated with a unique identifier. A non-limiting example of associating a unique identifier with an apparatus 1 is by the second wireless communication circuitry 3B being associated with a unique identifier for example in the form of a Media Access Control identifier (hereinafter called “MAC ID”), which is a MAC address.

An “in-application update” occurs when a transmitting apparatus 1 transmits second data through its second wireless communication circuitry 3B and a receiving apparatus 1 receives the second data through its second wireless communication circuitry 3B. An “in-application update” is wireless communication performed by the second wireless circuitry 3B of the transmitting apparatus 1 with the second wireless circuitry 3B of the receiving apparatus 1. When the application is a game application, the “in-application update” is hereinafter called “in-game update”.

The volatile memory 4 of this example embodiment is computer-readable storage medium capable of storing thereon predetermined applications of the present invention and the game parameters and the game state during an instance of game play.

Examples of volatile memory 4 includes RAM, Pseudo-SRAM (PSRAM) or computer-readable storage medium with similar functionality.

The first non-volatile memory 5 of this example embodiment is computer-readable storage medium capable of storing thereon predetermined applications of the present invention. Examples of non-volatile memory 5 include flash memory, memory card, memory cartridge, ROM (read-only memory), hard drive, solid state drive or computer-readable storage medium with similar functionality Predetermined applications executed by the CPU 2 may be stored in advance of an instance of game play on the first non-volatile memory 5, or downloaded from other computer-readable storage media (not shown) or downloaded from a network (for example the Internet) or downloaded from another apparatus 1. In certain embodiments of the present invention, apparatus 1 comprises the first non-volatile memory 5. Alternatively, in certain embodiments of the present invention, apparatus 1 may not comprise the first non-volatile memory 5; in this case, the game may still be played as the application may be stored on another storage medium, for example in a cloud computer-readable storage medium or on a computer hard drive, and the application may be downloaded to the volatile memory 4 of the apparatus 1 at inception of an instance of game play.

The second non-volatile memory 6 of this example embodiment is computer-readable storage medium capable of storing thereon the game state and game parameters associated with the game play subsequent to the end of an instance of game play.

Examples of non-volatile memory 6 includes EPROM memory or computer-readable storage medium with similar functionality. Alternatively, apparatus 1 may not comprise the second non-volatile memory 6. In this case, the game may still be played, and the game state and game parameters may either not be stored subsequent to the end of an instance of game play, or the game state and game parameters may be stored on another storage medium, for example flash memory, memory card, in a cloud computer-readable storage medium or on a computer hard drive, subsequent to the end of an instance of game play. The stored game state and game parameters may be downloaded at another time in order to be used during another instance of game play.

The video circuitry 7 of this example embodiment is capable of outputting, in a manner that is visually comprehensible to a user, information representative of game state or game parameters. The video circuitry 7 may output information to one or a plurality of any suitable video output devices (not shown) for example a video display, which may use any suitable video display technology, examples including LCD (Liquid Crystal Display), LED (Light-Emitting Diodes) or EL (Electro Luminescence). The video circuitry 7 may also receive information from a video input device, examples including a camera or video recorder. Alternatively, apparatus 1 may not comprise the video circuitry 7.

The audio circuitry 8 of this example embodiment is capable of outputting, in a manner that is audibly comprehensible to a user, information representative of game state or game parameters. The audio circuitry 8 may output information to any suitable audio interface (not shown), which may further output information to one or a plurality of audio output devices (not shown). Examples of audio interface include 3.5 mm audio jack or Bluetooth interface. The audio interface may be in communicative connection with an audio output device, for example headphones or earphones. Alternatively, the audio circuitry 8 may output information to an audio output device, for example speaker. Alternatively, apparatus 1 may not comprise the audio circuitry 8.

Apparatus 1 may further comprise an audio input device (not shown) in communicative connection with the audio circuitry 8. The audio input device is capable of obtaining information that is audibly communicated by a user, for example the user's words. The information may be further inputted through the audio circuitry 8 to the CPU 2. The CPU 2 of apparatus 1 is capable of transmitting the information representative of the audible information communicated by a user, for example through the wireless communication circuitry 3B. The audio circuitry 8 is also capable of outputting, in a manner that is audibly comprehensible to a user, information representative of audible information communicated by another user. In this way, audio communication between users is enabled. The CPU 2 may be configured to transmit the information representative of the audible information communicated by a user to other apparatuses 1 based on the game state or game parameters, for example the information may be transmitted solely to apparatuses with the assigned role of team members of the same team as the apparatus 1, thus enabling communication during the game play between users assigned to the same team.

Alternatively, apparatus 1 may comprise other circuitry capable of outputting, in a manner that is in another way comprehensible to a user, for example through haptic effects, information representative of game state or game parameters.

Apparatus 1 of this example embodiment may further comprise an actuator 9 capable of being actuated by a user. Non-limiting examples of actuators 9 include buttons, levers, switches, triggers, handles, sensors that are capable of detecting haptic input from a user or other actuators. Alternatively, the actuator 9 may comprise other input devices capable of being actuated by a user, for example audio input device for example a microphone capable of receiving audio input from a user. Upon actuation by a user, the actuator 9 inputs actuation information to the CPU 2. The CPU 2 is capable, in response to receiving the actuation information, to transmit first data 15 through the wireless communication circuitry 3A to another apparatus 1.

Apparatus 1 of this example embodiment may further comprise a housing (not shown) capable of being portable by a user. Predetermined components of the apparatus 1 may be accommodated on or within the housing. The housing may have any shape, for example shapes associated with action, adventure, shooting, fantasy, treasure-hunting and other games for example a gun, a sword, a knife, a wand, a laser sword; shapes resembling nature-made or man-made objects for example Earth-shape, fountain-shape, gold bullion-shape; geometrical shapes for example sphere, conic; or irregular shapes. The housing may accommodate all components of apparatus 1. Alternatively, predetermined components of apparatus 1 may not be accommodated on or within the housing, for example components of first wireless communication circuitry 3A or components of second communication circuitry 3B may be body-worn for example on clothes or wrist or head-worn by a user instead of being accommodated on or within the housing; or an audio output device (not shown) connected to the audio circuitry 8 may be body-worn or head-worn for example ear-worn. As another example, the video circuitry 7 or the audio circuitry 8 or components of first wireless communication circuitry 3A or components of second communication circuitry 3B or other components of apparatus 1 may be accommodated in close proximity to the apparatus 1, for example in a themed physical setting or location. For example, if the setting is a building, the video circuitry 7 or the audio circuitry 8 or components of first wireless communication circuitry 3A or components of second communication circuitry 3B or other components of apparatus 1 may be accommodated on walls or themed objects, or for example if the setting is a field, the video circuitry 7 or the audio circuitry 8 or components of first wireless communication circuitry 3A or components of second communication circuitry 3B or other components of apparatus 1 may be accommodated on trees, or fences. The housing may, but is not required to, be interchangeable, in other words an apparatus 1 may be temporarily accommodated on or within a housing, or it may detached from that housing and re-accommodated on or within another housing. For example in one instance of a game play an apparatus 1 may be accommodated within a housing resembling a gun but in another instance of a game play the same apparatus 1 may be accommodated within a housing resembling a hill, by reference to the “king of the hill” game described by reference to FIG. 9. Alternatively an apparatus 1 may be permanently accommodated on or within a housing.

Apparatus 1 may further comprise power supply circuitry (not shown) which supplies power to the components of apparatus 1. The power supply circuitry obtains power from a power source (not shown). An example of a power source includes one or more batteries connected with the power supply circuitry through any suitable connections which are well understood by one skilled in the art.

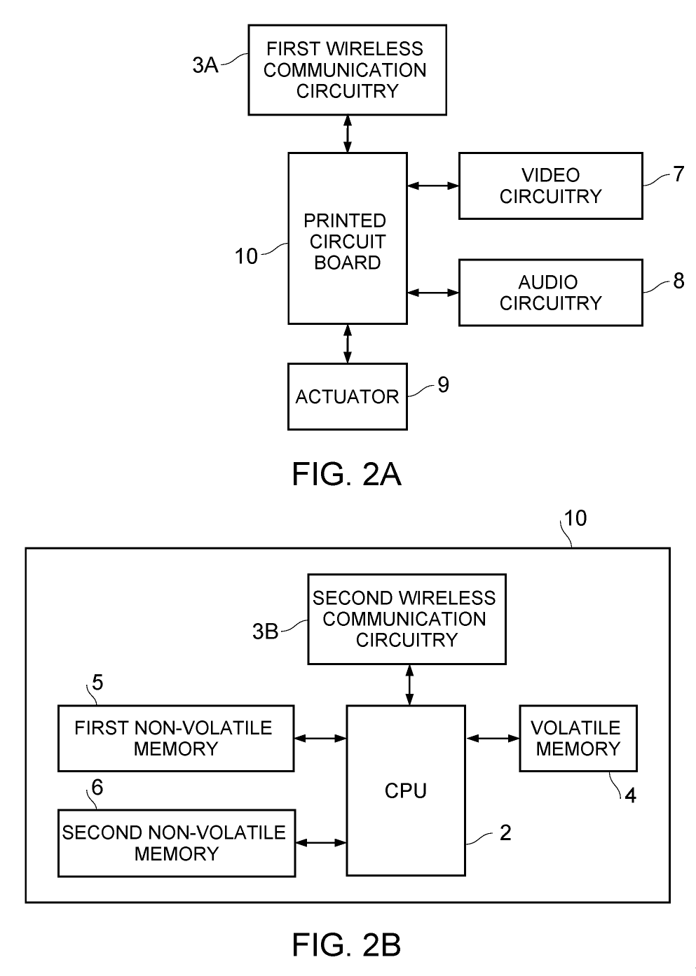

FIG. 2A is a block diagram showing another non-limiting example of the internal configuration of an apparatus 1 according to an embodiment of the present invention. In this example embodiment, apparatus 1 comprises a printed circuit board 10, first wireless communication circuitry 3A, video circuitry 7, audio circuitry 8, actuator 9 or components with similar functionality. The first wireless communication circuitry 3A, video circuitry 7, audio circuitry 8 and actuator 9 are in communicative connection with the CPU 2 of the printed circuit board 10 through any suitable connections which are well understood by one skilled in the art. The printed circuit board 10 is described by reference to FIG. 2B.

FIG. 2B is a block diagram showing a non-limiting example of the internal configuration of a printed circuit board 10. The printed circuit board 10 in this example embodiment comprises the following components which are pre-mounted on an electronic circuit board (not shown) and interconnected through any suitable connections which are well understood by one skilled in the art: CPU 2, second wireless communication circuitry 3B, volatile memory 4, first non-volatile memory 5 and second non-volatile memory 6. Other examples of printed circuit board 10 (not shown) may include other combinations of components described by reference to FIG. 1 which are pre-mounted and interconnected. Each component which is pre-mounted and interconnected on a printed circuit board 10 has the same function as the same named and numbered component which is not pre-mounted, and is described by reference to that component in FIG. 1. Hereinafter, apparatuses 1A, 1B, 1C, 1D, 1S, 1B1, 1B2, 1B3, 1C1 and 1C2 shown in all other figures are apparatuses 1 described by reference to FIG. 1, FIG. 2A and FIG. 2B. FIG. 3A and FIG. 3B are sequence diagrams showing non-limiting examples of transmission and reception of first data and transmission and reception of second data performed in an embodiment of the present invention. FIG. 3A is followed in sequence by FIG. 3B.

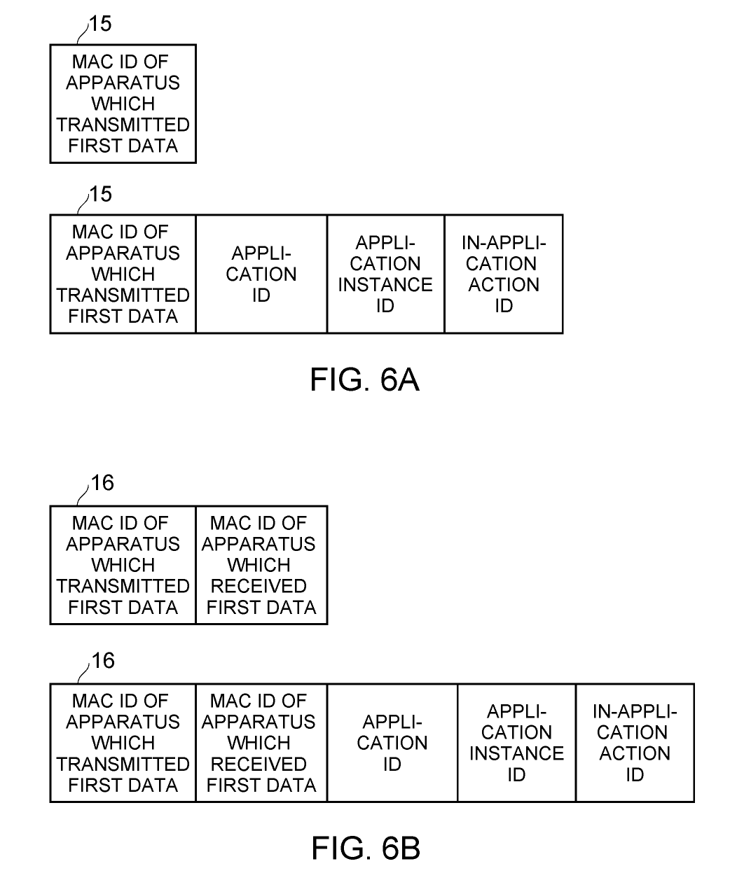

FIG. 3A is a diagram showing a non-limiting example of an embodiment, in which apparatus 1B performs in-application action with apparatus 1A when apparatus 1B transmits first data 15 through one or more wireless communication signals 20A by the wireless communication circuitry 3A and apparatus 1A receives first data 15 through one or more wireless communication signals 20A by the wireless communication circuitry 3A. In this example, apparatus 1B transmits one or more wireless communication signals 20A in response to a user actuation of the actuator 9 of apparatus 1B. First data 15 is described by reference to FIG. 6A.

FIG. 3B is a diagram showing a non-limiting example of an embodiment, in which apparatus 1A performs in-application updates with apparatuses 1B, 1C and 1D, when apparatus 1A transmits second data 16 through one or more wireless communication signals 21B, 21C and 21D to apparatuses 1B, 1C and 1D respectively by the wireless communication circuitry 3B and apparatuses 1B, 1C and 1D receive second data through one or more wireless communication signals 21B, 21C and 21D respectively by the wireless communication circuitry 3B. In this example, apparatus 1A transmits one or more wireless communication signals 21B, 21C and 21D in response to receiving first data through the one or more wireless communication signals 20A transmitted by apparatus 1B by reference to FIG. 3A. Second data 16 is described by reference to FIG. 6B.

FIG. 3A and FIG. 3B show in-application action and in-application updates between selected apparatuses as a non-limiting example. However, in-application actions between any apparatuses and in-application updates between any apparatuses may be performed in this embodiment of the present invention. First data 15 may be transmitted by any apparatus and received by any other apparatus through one or more wireless communication signals and second data 16 may be transmitted by any apparatus and received by any other apparatus through one or more wireless communication signals. In other words, first data 15 may be received by apparatus 1A or 1C or 1D upon being transmitted by any other apparatus other than the apparatus receiving first data 15; and second data 16 may be transmitted by apparatus 1A or 1B or 1C or 1D respectively upon receiving first data 15, and second data 16 may be received by all apparatuses other than the apparatus transmitting second data 16.

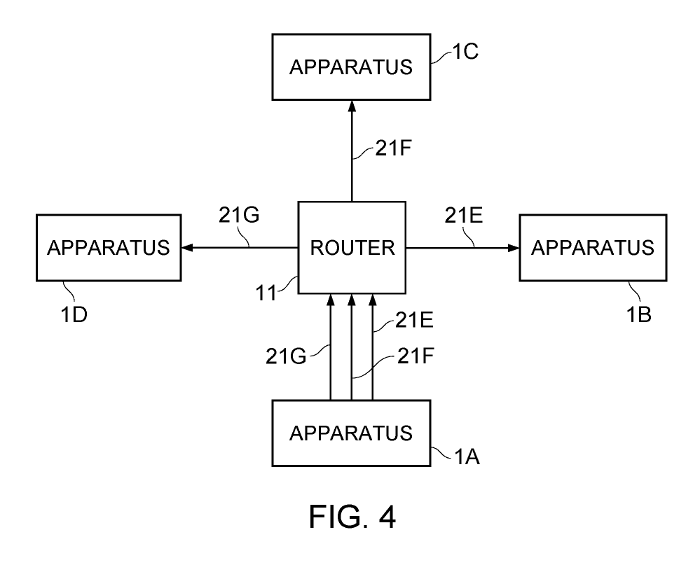

FIG. 4 is a diagram showing a non-limiting example of an embodiment, in which transmission and reception of wireless communication signals is via routing circuity 11. A non-limiting example of routing circuitry 11 is a Wi-Fi wireless router of a wireless standard compatible with and capable of performing wireless communication with the second wireless circuitry 3B, for example wireless router operating in the approximately 2.4 GHz (gigahertz) and 5 GHz frequencies, or other frequencies. The routing circuitry 11 is capable of routing Wi-Fi communication signals.

The diagram in FIG. 4 shows a non-limiting example of apparatuses 1A performing in-application updates with apparatuses 1B, 1C and 1D through the routing circuitry 11. For example, apparatus 1A performs in-application update with apparatus 1B when apparatus 1A transmits second data 16 through one or more wireless communication signals 21 E to the routing circuitry 11 by the second wireless communication circuitry 3B and the routing circuitry 11 routs the wireless communication signal 21E to apparatus 1B. Apparatus 1B receives the wireless communication signal 21E through the routing circuitry 11 by the second wireless communication circuitry 3B of apparatus 1B.

The use of a routing circuitry 11 may enable enlargement of the geographic area over which in-application updates are communicated, to include the communicable range of the routing circuitry 11.

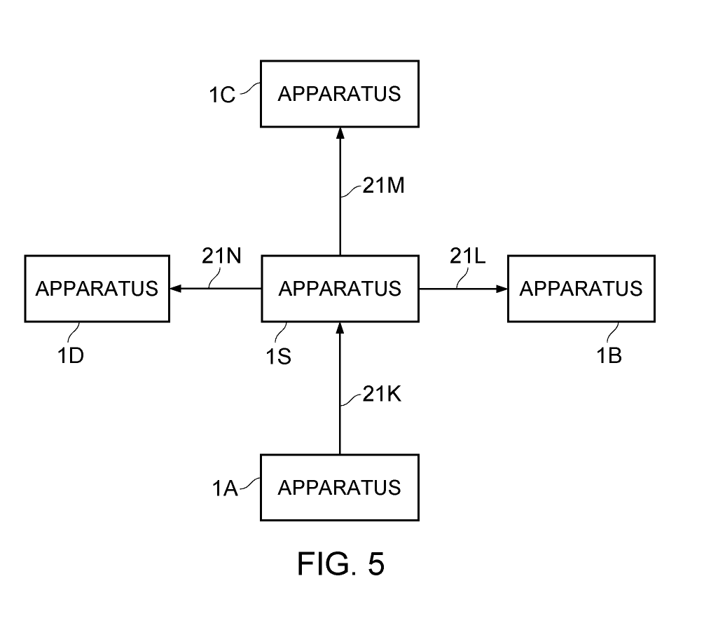

FIG. 5 is a non-limiting example of an embodiment, in which one of the apparatuses 1S performs amplification and centralization of transmission and reception of second data 16 through wireless communication signals. The apparatus 1S is capable of functioning as an amplification and communications hub or center for the transmission and reception of second data 16 through wireless communication signals between the other apparatuses 1.

As an alternative to an apparatus 1 transmitting second data 16 to all other apparatuses 1 as described by reference to FIG. 3B, FIG. 5 shows that an apparatus 1 may transmit second data 16 to the apparatus 1S, and the apparatus 1S may then transmit the second data 16 to all other apparatuses 1. Thus, apparatus 1S is capable of functioning as a hub or center for the transmission and reception of second data 16 through wireless communication signals between the other apparatuses 1. Communication of second data 16 through an apparatus 1S may reduce the number of wireless communication which need to be performed between all apparatuses 1 and thus increase the speed of the totality of the wireless communication between all apparatuses 1.

Apparatus 1S is also capable of amplifying the wireless communication signals which transmit second data 16. For example, the wireless communication circuitry 3B of apparatus 1S may comprise amplification circuitry, for example a wireless antenna which has a higher gain, with a larger number of dBi, than the other apparatuses 1A, 1B, 1C and 1D. Thus, apparatus 1S is capable of transmitting second data 16 through amplified wireless communication signals to the other apparatuses 1. This capability of apparatus 1S may enable enlargement of the geographic area over which in-application updates are communicated, to include the communicable range of the apparatus 1S. The apparatus 1S is also capable of functioning as an information processing hub or center for performing predetermined processes of the application. This capability of the apparatus 1S in no way affects the already-stated capabilities of each apparatus 1 to perform process the application. Each CPU 2 of each apparatus 1 is information processing circuitry capable of executing predetermined processes of the applications of the present invention, for example to use the first data 15 to attain objectives, and to use the second data 16 to obtain information about each of the plurality of apparatuses 1 attaining objectives. Alternatively, in this non-limiting example of an embodiment, solely the apparatus 15 may perform predetermined processes of the application. As an example, when apparatus 1B sends first data 15 to apparatus 1A by reference to FIG. 3A, apparatus 1A may perform certain processes of the application for example cause the second wireless circuitry 3B to transmit second data 16. By reference to FIG. 5, apparatus 15 may perform processes of the application different than those performed by apparatus 1A, for example processing that apparatus 1B or 1A attained an objective of the application. In other words, in FIG. 3B apparatus 1A performed processes of the application that apparatus 1B or 1A attained an objective of the application, whereas alternatively in FIG. 5 apparatus 15 performed processes of the application that apparatus 1B or 1A attained an objective of the application. This is a non-limiting example that not all the capabilities of the apparatuses 1 need to be used in exactly the same way to each other; rather some apparatuses 1 may use some capabilities differently than other apparatuses 1.

FIG. 6A is a diagram showing a non-limiting example of first data 15 according to an embodiment of the present invention. First data 15 is transmitted by the first wireless communication circuitry 3A of the apparatus 1 for example in response to user actuation of the actuator 9. In this example, first data 15 is transmitted by the first wireless communication circuitry 3A of apparatus 1 through one or more IR communication signals. First data 15 may comprise an unique identifier of the apparatus 1 which transmitted first data 15, for example the MAC ID of the apparatus 1. First data 15 may further comprise, but is not required to comprise, one or more of the following: a unique identifier of the application (hereinafter called “application ID”); a unique identifier of the instance of the application (hereinafter called “application instance ID”); and an identifier of the type of in-application action (hereinafter called “in-application action ID”). FIG. 6A shows an example of first data 15 comprising all of the MAC ID of the apparatus 1 which transmitted first data 15, the application ID, the application instance ID and the in-application action ID. The application ID is usable for example if a plurality of different applications are executed in close geographical proximity to each other and the application ID identifies which application the first data 15 or second data 16 pertain to. The application instance ID is usable for example if a plurality of application instances of the same application are played in close geographical proximity to each other and the application instance ID identifies which instance of the application the first data 15 or second data 16 pertain to. The in-application action ID is usable to identify the type of in-application action, for example if different in-application actions may be performed by transmitting and receiving first data 15. For example in a game application, a user is called a player. For example by reference to the game of “king of the hill” described by reference to FIG. 9, a player may have different in-game powers, and may use them to perform different in-game actions. A player may have a type of power to shoot another player with a “regular” shot, which accomplishes the in-game objective of taking away one in-game life from the player that was shot; or the player may have a type of power to shoot another player with a “power” shot, which accomplishes the in-game objective of taking away two in-game lives from the player that was shot; or a type of power to shoot another player with an “inactivating” shot, which accomplishes the in-game objective of making the in-game status of the player that was shot “inactive”, where this in-game status makes the player having this status unable to perform in-game actions for a predetermined time period; or a type of power to send an “all-around” shot, which accomplishes the in-game objective of shooting all players within a communicable range at once, or many other types of powers which may be based on one or more of the application, the game parameters, the game state, the type of actuation or actuator, for example each of a plurality of actuators may be actuated to perform a plurality of predetermined in-game actions which may differ from each other.

The CPU 2 performs processes of the application by using the first data 15. For example, the CPU 2 may use the first data 15 to perform processes which are that apparatus 1 which received or transmitted the first data 15 attains objectives of the application.

FIG. 6B is a diagram showing a non-limiting example of second data 16 according to an embodiment of the present invention. Second data 16 is transmitted by the second wireless communication circuitry 3B of the apparatus 1 for example in response to receiving first data 15. In this example, second data 16 is transmitted by the second wireless communication circuitry 3B of apparatus 1 through one or more Wi-Fi communication signals. Second data 16 may comprise an unique identifier, for example, the MAC ID, of the apparatus 1 which transmitted second data 16, which is the same as the apparatus 1 which received first data 15, as well as an unique identifier, for example the MAC ID, of the apparatus 1 which transmitted first data 15.

Second data may further comprise, but is not required to comprise, one or more of the following: an application ID, an application instance ID and an in-application action ID, which are described by reference to FIG. 6A. FIG. 6B shows an example of second data 16 comprising all of the MAC ID of the apparatus 1 which transmitted first data 15, the MAC ID of the apparatus 1 which received first data 15, the application ID, the application instance ID and the in-application action ID.

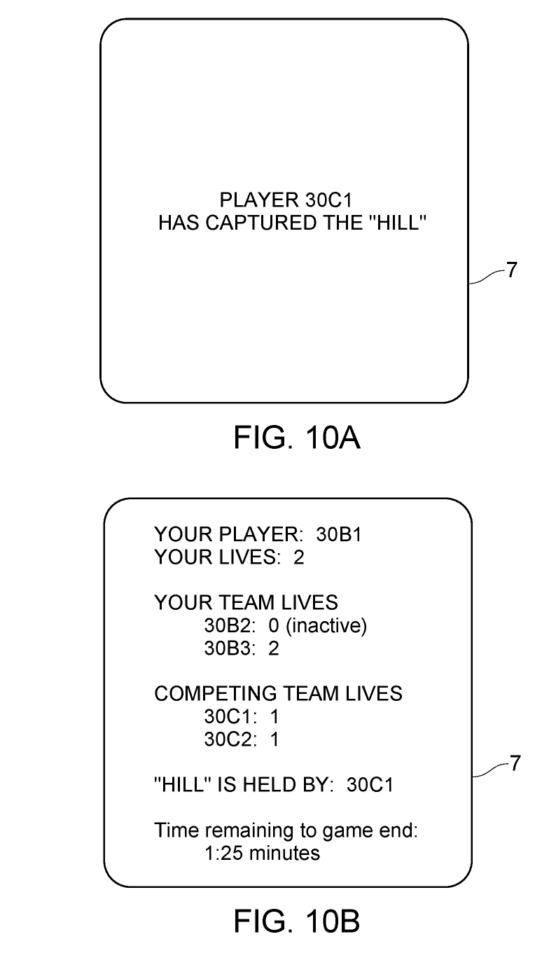

The CPU 2 of the apparatus 1 which receives second data 16 performs processes of the application by using the second data 16. For example, the CPU 2 may use the second data 16 which the apparatus 1 received to obtain information about any of the plurality of apparatuses 1 attaining objectives of the application, as further exemplified by reference to FIG. 10A and FIG. 10B. By reference to FIG. 5, the CPU 2 of a predetermined apparatus 1S may also perform processes of the application by using the second data 16, which comprises at least the information comprising first data 15, to perform processes of the application which are that apparatus 1 which received or transmitted the first data 15 attains objectives of the application.

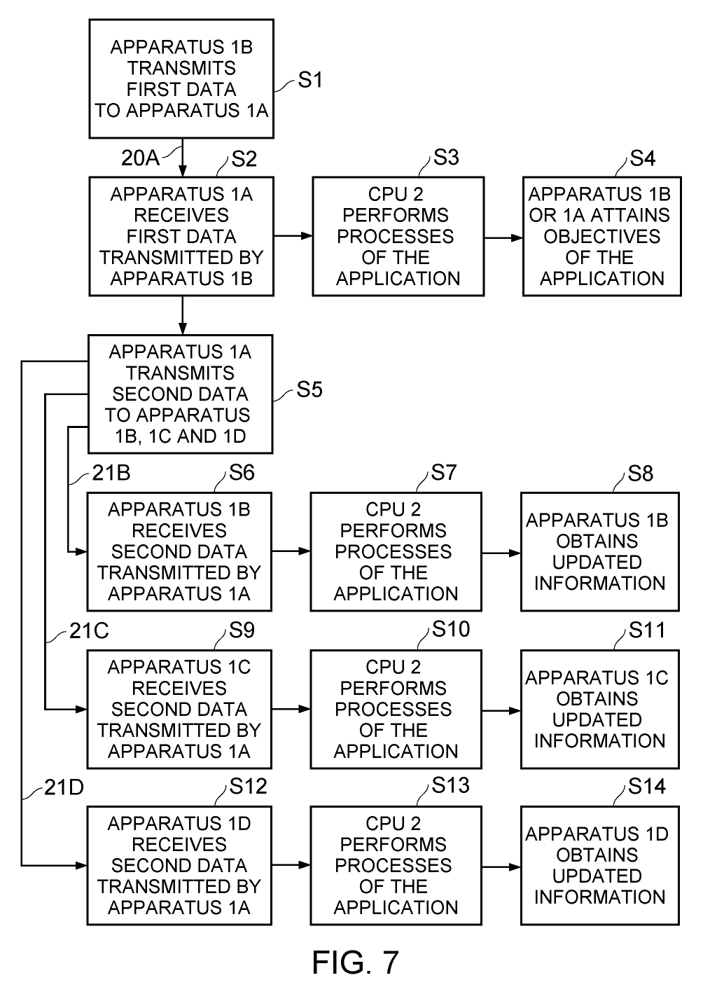

FIG. 7 is a flowchart showing a non-limiting example of sub-processes which may be performed according to an embodiment of the present invention by reference to FIG. 3A and FIG. 3B. At sub-process S1, apparatus 1B transmits first data 15 through one or more wireless communication signals 20A. At sub-process S2, apparatus 1A receives first data 15 transmitted by apparatus 1B. At sub-process S3, the CPU 2 uses first data 15 to perform predetermined processes of the application. At sub-process S4, an example of the predetermined processes is to attain objectives of the application.

At sub-process S5, apparatus 1A transmits second data 16 through one or more wireless communication signals 21B, 21C and 21D for example in response to apparatus 1A receiving first data 15 as described in sub-process S2.

At sub-process S6, apparatus 1B receives second data 16 transmitted by apparatus 1A.

At sub-process S7, the CPU 2 uses second data 16 to perform other predetermined processes of the application. At sub-process S8, an example of other predetermined processes is to obtain updated information about attained objectives of the application.

At sub-process S9, apparatus 1C receives second data 16 transmitted by apparatus 1A.

At sub-process S10, the CPU 2 uses second data 16 to perform other predetermined processes of the application. At sub-process S11, an example of other predetermined processes is to obtain updated information about attained objectives of the application.

At sub-process S12, apparatus 1D receives second data 16 transmitted by apparatus 1A. At sub-process S13, the CPU 2 2 uses second data 16 to perform other predetermined processes of the application. At sub-process S14, an example of other predetermined processes is to obtain updated information about attained objectives of the application.

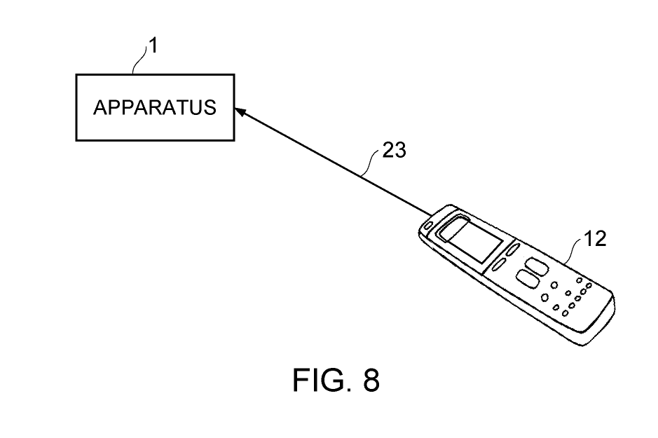

FIG. 8 is a diagram showing a non-limiting example of an embodiment of the present invention, in which the CPU 2 processes an assignment of a role of the application to the apparatus 1. The assignment of a role may be performed for example by using a remote controller 12, for example a general purpose TV remote controller, which communicates with the apparatus 1 for example using IR communication signals 23.

The design of the remote controller 12, such as the placement of buttons on the remote controller, is not part of the present invention. A user may actuate the remote controller to select a role assignment from a set-up menu containing a number of predetermined roles of the application. Once the user has selected a role, the CPU 2 processes an assignment of that role to the apparatus 1. An apparatus may be assigned one or more roles. Each application may include many predetermined roles which a user may select from. For example, in a “king of the hill” game enabled by a “king of the hill” application, roles may include the object role of “hill”, the character role of “member” of a predetermined team, and the character role of “captain” of a predetermined team. Other roles may be assigned based on the application. For example, in a game application which is a “wizardry” application enabling a “wizardry” game, assigned roles may be player character roles and non-player character roles, such as “chief wizard”, “sub-chief wizard”, “simple wizard”, “dragon”, “elf”, “hobbit”, object roles such as “magic globe”, “doorway to the magic world”, “fountain of life” and other roles based on the application.

A player character role is a character role assigned to an apparatus 1 which is handled by a player, whereas a non-player character role is a character role assigned to an apparatus 1 which is not handled by a player.

Another way (not shown) of assigning a role within the game play to an apparatus 1 may be based on one or more of the application, game parameters or game state.

Game parameters and game state are further described below. For example, a “non-captain member” of a team may become the “captain” of a team based on the application and game state, for example by obtaining a predetermined number of points, or number of lives, or more points or lives than other “non-captain members” of the same team, or by attaining objectives within the game play or by in other ways modifying the game state.

The apparatuses 1 also may be assigned predetermined roles, without the need for the player to select a role and for the CPU 2 to process of assignment of a role to the apparatus 1.

The attained objectives of the application upon performance of in-application actions is based on the application. The attained objectives of the application upon performance of in-application actions may be further based on the execution of predetermined processes of the application, for example the assigned role of the apparatus 1 transmitting first data or the assigned role of the apparatus 1 receiving first data, or both assigned roles. As another example, by reference to a game application, the attained objectives of the application upon performance of in-game actions may further be based on predetermined game parameters or game state.

Game parameters comprise information that characterizes the entire instance of the game play. Non-limiting examples include the application, the game level, the game rules, predetermined objectives, predetermined roles, predetermined activities, predetermined in-game assets, predetermined in-game powers.

Game state comprise information that characterizes the instance of the game play at a predetermined point in time, which may differ from this information at another predetermined point in time. Non-limiting examples include in-game assets for example number of points or number of lives or other in-game assets, in-game powers, assigned roles of the apparatuses 1, status of the apparatuses 1 (for example active, inactive) at a predetermined point in time.

Next is described by reference to FIG. 9 a game of “king of the hill” which is provided to game players via embodiments of the present invention.

FIG. 9 is a diagram showing a non-limiting example of an embodiment of the present invention applied as an apparatus 1 enabling a “king of the hill” game, a non-volatile computer-readable storage medium 5 storing a “king of the hill” application, a system enabling a “king of the hill” game, and a method for providing a “king of the hill” game.

The application causes the apparatus 1 to perform processes of the application, whereby it enables a player who handles apparatus 1 to participate in a “king of the hill” game. The application comprises computer-executable program regarding, for example, predetermined rules, objectives, in-game roles, in-game activities, in-game assets and in-game powers of a “king of the hill” game. The application is determinative of the rules, objectives, in-game roles, in-game activities, in-game assets and in-game powers of the game being played.

Next are described roles of an application.

In this non-limiting example embodiment, the roles of the application are player character roles and object roles, as further described below. Other types of roles may be assigned in embodiments of the present invention, a non-limiting example being non-player character roles, which are character roles assigned to apparatuses which are not handled by players. Each player 30B1, 30B2, 30B3, 30C1, and 30C2 handles one apparatus 1, namely 1B1, 1B2, 1B3, 1C1 and 1C2 respectively. The apparatuses 1B1, 1B2, 1B3, 1C1 and 1C2 have a housing resembling the physical form of a gun.

Apparatus 1A is not handled by a player. In this non-limiting example embodiment, apparatus 1A has a housing resembling the physical form of a geographic hill. The roles assigned within the game play to the apparatuses 1 are as follows:
Apparatus 1A is assigned the role of “hill”, which is an object role.
Apparatus 1B1 is assigned the role of “member of team B”, which is a player character role.
Apparatus 1B2 is assigned the role of “member of team B”, which is a player character role.
Apparatus 1B3 is assigned the role of “member of team B”, which is a player character role.
Apparatus 1C1 is assigned the role of “member of team C”, which is a player character role.
Apparatus 1C2 is assigned two roles, namely the role of “member of team C” and the role of “captain”, both of which are player character roles.

Next are described rules of an application.

In this non-limiting example embodiment, the game rules are such that the game is played in two teams, and the game is won by the team whose team member “captures” the “hill” and maintains this capture for a predetermined period of time, for example 2 minutes. In this non-limiting example, the “hill” refers to the apparatus 1A which is assigned the in-game role of hill and “capturing” the hill is an in-game activity which refers to a player causing the apparatus 1 it handles to perform in-game action with apparatus 1A.

A timer enabled by the CPU 2 is capable of performing a timer function and starts counting until 2 minutes lapse from the time the hill is captured. If 2 minutes lapse and the hill is not captured by another player from the competing team, the game is won by the team of the player which captured the hill. If another player from the competing team captures the hill, then the timer resets, counting until 2 minutes lapse from the reset time. However, if another player from the same team captures the hill, then the clock does not reset, rather it keeps counting based on the original 2 minutes.

In this non-limiting example embodiment, the game rules are such that each player has initial in-game assets which are an initial number of lives, in this example two lives. In this example, “shooting” is an in-game activity which refers to a player causing the apparatus 1 it handles to perform in-game action with another apparatus 1 handled by another player. If a player shoots another player from the competing team, the number of lives of the player that was shot decreases by one life, in other words the player that was shot loses one life. In this non-limiting example, a game rule is that if a player's life count becomes zero, his or her in-game status becomes “inactive”; otherwise his or her game status is “active”. Another game rule is that if a player's status is “inactive”, the in-game actions of the player have no effect on the game state.

If a player shoots another player from the same team, the number of lives of the player that was shot is unchanged, in other words it has no effect on the game state. If a player shoots another player from the same team and the player who is being shot is in inactive status, the number of lives of the player that was shot is increased by one life while the number of lives of the player that shot is decreased by one life, in other words, a player may transfer one of his or her lives to a co-team member. This is an example in which an in-game action is assigned a meaning within the game play based on the game state, namely a meaning within the game play was assigned based on whether the player being shot was in an active or inactive status. This is a non-limiting example, as the assigned meaning within the game play of an in-game action may be based on any one or more of the application, any of the information which comprises the game state, any of the information which comprises the game parameters, type of actuation or actuator and other information related to the application. There may therefore be a vast number of combinations of in-game information on which the assigned meaning within the game play of an in-game action may be based, allowing for a vast number of different games to be played.

Next are described in-game activities of a game.

In-game activities include in-game actions and other activities performed by the players in connection with the game play, as further describe below. For ease of reference, a reference to a player performing an in-game action which is enabled by an apparatus 1 indicates that the player causes the apparatus 1 that the player is handling during the game play to perform the in-game action.

Many in-game activities may be performed concurrently. For example, player 30C1 may shoot the hill at the same time that player 30B1 shoots player 30C2 and at the same time that player 30C2 shoots player 30B2.

In addition to in-game actions, players may perform any of numerous activities connected with the game play, for example physical activities for example handling apparatus 1, running, walking, jumping, sprinting, hiding, ducking, climbing, obstacle course scampering, mud running, or mental activities for example strategizing, or other activities for example communicating with other players, speaking, listening. These activities are solely non-limiting examples; the types of activities the players may perform are at the player's discretion and in no way limit embodiments of the present invention. As non-limiting examples, a player may run to arrive at the hill faster to enable the player to be the first one to capture the hill; a player may ditch to avoid being shot by another player from the opposite team; players may talk to plan their in-game activities. Players may perform any activity which is appropriate to enable the players to follow the game rules and accomplish the game objectives.

Next are described objectives of an application.

In-game objectives which may be attained are based on the application. There could be multiple in-game objectives based on the application.

Non-limiting examples of in-game objectives are: obtaining lives, points, objects, powers, or taking away lives, points, objects or powers from other competing players. In this non-limiting example embodiment, in a “king of the hill” game, objectives of the application are that the players try to attain are to capture the hill and maintain the capture for the subsequent 2 minutes. Players try to maintain the capture of the hill by not allowing players from the competing team to capture the hill. Player also try to avoid losing lives while also causing the players on the competing team to lose lives.

A player may accomplish objectives within the game play by performing in-game activities including in-game actions and other activities. In-game actions have assigned meanings within the game play based on at least the application, and may be, but is not required to be, further based on one or more of the assigned role within the game play of the receiving apparatus 1, the assigned role within the game play of the transmitting apparatuses 1, predetermined game parameters, predetermined game state, type of actuation or actuator, or other information associated with the application. If a player shoots the hill, the player accomplishes the in-game objective of capturing the hill. If a player shoots another player from the competing team, the player which shot the other accomplishes an in-game objective of reducing the number of lives of a player from the competing team. If a player shoots another player sufficient times that the number of lives of the player that was shot is reduced to zero, the player which shot the other accomplishes an in-game objective of making the player from the competing team inactive, in other words without the capability of further affecting the game state. Game objectives may be accomplished by the player or players whose apparatus 1 transmitted first data, the player or players whose apparatus 1 received first data, or both the player or players whose apparatus 1 transmitted, and the player or players whose apparatus 1 received first data. As a non-limiting example, a player who shot a player of the opposing team may obtain the in-game objective of reducing the number of in-game lives of the player that was shot; this is an example of the player whose apparatus 1 transmitted first data attaining in-game objectives. As another non-limiting example, a player may shoot a player of the same team, and this in-game action would have the assigned meaning that the player whose apparatus 1 received first data obtains one in-game life from the player whose apparatus 1 transmitted first data; this is an example of the player whose apparatus 1 received first data attaining in-game objectives.

FIG. 10A and FIG. 10B are diagrams showing non-limiting examples of the video circuitry 7 outputting, via a video output device for example a video display, information representative of game rules, objective, assigned roles, state or game parameters. FIG. 10A is a diagram showing a non-limiting example of the video circuitry 7 outputting a graphical representation of an in-game activity which is performed by player 30C1 by causing apparatus 1C1 to perform in-game action with apparatus 1A, by reference to FIG. 9. In this example graphical representation, the representation includes the identification of the player 30C1 who handles the apparatus 1C1 which performed the in-game action, and the assigned meaning within the game play of the in-game action, which is that the player has captured the hill.

FIG. 10B is a diagram showing a non-limiting example of the video circuitry 7 outputting a graphical representation of the game state, including information about the identification of the player 30B1 who handles the apparatus 1B1 which comprises the video circuitry 7 in this diagram, information about in-game assets, more specifically in-game number of lives of the same player 30B1, identification of other players 30B2 and 30B3 who are assigned in-game roles of members of the same team as player 30B1, information about in-game assets, more specifically in-game number of lives of the same players 30B2 and 30B3, identification of other players 30C1 and 30C2 who are assigned in-game roles of members of the opposite team as player 30B1, information about in-game assets, more specifically in-game number of lives of the same players 30C1 and 30C2, selected game state information about which player has capture of the hill, and selected game state information about the time remaining in the instance of the game play.

There may be a vast number of combinations of in-game information which may be graphically represented and outputted by the video circuitry 7. This information may be based on any one or more of the following: the application, any of the information which constitutes the game state, any of the information which constitutes game parameters, type of actuation or actuator, all of which are based on the application.

Next are described other non-limiting examples of games which are provided to game players via embodiments of the present invention.

Numerous types of games may be provided to game players via embodiments of the present invention. The method enabled by a plurality of information processing devices, comprising transmitting first data; receiving first data; transmitting second data in response to receiving first data; receiving second data; performing processes of an application by using first data; and performing processes of an application by using the second data, may be applied to numerous applications in addition to the “king of the hill” application described herein.

In regards to a “king of the hill” game, numerous games and game variants are enabled by embodiments of the present invention. To name a few, variants of the “king of the hill” game may be based on variants of the application, by varying one or some of the game parameters for example rules, roles, objectives, activities. For example, variants may exist based on the rules as to when a game is won. For example the game may be won the team in which a team member is the first to capture the hill; or by the first team in which two team members have captured the hill sequentially. As another example, variants may exist based on other game parameters, for example, a “shot” may have the in-game meaning that it decreases the number of in-game lives of the player handling the receiving apparatus 1, whether that is held by a player on the same or the opposing team. As another example, in-game assets may include additional powers, for example double power, which, if used by a player with a role of “captain” of a team, has double effect of reducing the number of lives of the receiving apparatus 1 by two lives.

Each game rule, objective, activities, roles, game level, and other game parameters mentioned above may be changed to create another variant based on the application.

Therefore, one skilled in the art will understand that the number of possible game variants is vast, based on a vast number of variants of the application.

Similarly to the vast number of variants of a predetermined game, a vast number of different games are also enabled by embodiments of the present invention. The following are non-limiting examples of games enabled by embodiments of the present invention. One skilled in the art will understand that this is a non-limiting exemplary list, and that a vast number and variety of other games are enabled by embodiments of the present invention.

A non-limiting example is a game of “Protect the VIP”, which is provided to game players via embodiments of the present invention, wherein the application is a “Protect the VIP” application. In this game, one apparatus 1 is assigned the role of “VIP” in each team; other apparatuses 1 are assigned roles of team members. The objectives are for the team members to protect the VIP on their own team, while shooting the VIP on the opposite team in order to eliminate that VIP. The team which is successful in eliminating the other team's or teams' VIP while protect their own VIP from being eliminated, wins the game. In this game, a player can perform a shot for example by performing in-game action with another player. Elimination of a player from the game can be accomplished for example by reaching a predetermined number of shots.

Another non-limiting example is a game of “Capture the Flag”, which is provided to game players via embodiments of the present invention, wherein the application is a “Capture the Flag” application. In this game, one apparatus 1 for each team is assigned the role of “flag”. The objectives are for a team to capture the flag of the opposite team and bring it into their own base. Capturing the flag can be accomplished for example by performing in-game action with the flag; and bringing the captured flag to the base can be accomplished for example by the same player which captured he flag performing in-game action with his or her own team's flag.

Another non-limiting example is a “Deathmatch” game, which is provided to game players via embodiments of the present invention, wherein the application is a “Deathmatch” application. In this game, the player who shoots the greatest number of in-game enemies wins the game. Variants include that the player who shoots the number of enemies with the greatest assigned in-game score for example number of points (for example if different enemies are assigned different number of points), or the player who shoots certain predetermined enemies, or the player who shoots the greatest number of enemies within a certain timeframe, wins the game. In this game, a player may shoot another player for example by performing in-game action with another player.

A variant of a Deathmatch game is a “Mutant” game which is provided to game players via embodiments of the present invention, wherein the application is a “Mutant” application. In this game, the player who reaches first a predetermined number of lives or points, or has the greatest number of lives or points at a predetermined time, wins the game. In this game, the first player to shoot another player is assigned the in-game role of mutant; obtains a predetermined number of in-game lives or points; obtains a different type of shooting ability by which a shot takes away a greater number of lives from a player that the mutant shot; and the game rules are that every other player can only shoot the mutant, but the mutant can shoot every other player. Another player can become the mutant by shooting the player who was the previous mutant. In this game, a player may shoot another player for example by performing in-game action with another player.

Another non-limiting example is a “Domination” game, which is provided to game players via embodiments of the present invention, wherein the application is a “Domination” application. In this game, the player who obtains or maintains domination over one or more in-game objects wins the game. In this game, a player may obtain domination over an in-game object for example by performing in-game action with the apparatus 1 which is assigned the role of that object; or for example may obtain the in-game object from another player by performing in-game action with another player who already had previously obtained the in-game object. A player may maintain domination for example by blocking other players from obtaining the in-game actions he or she had previously obtained by blocking them from performing in-game action with his or her own apparatus 1.

Another non-limiting example is a “Treasure Hunt” or “Scavenger” game, which are provided to game players via embodiments of the present invention, wherein the application is a “Treasure Hunt” or “Scavenger” application. In these games, the player who first locates and obtains one or more in-game objects wins the game. Variants are that the player who obtains the predetermined in-game objects with predetermined characteristics, for example if each object has a different associated number of points or other characteristics, wins the game. In this game, a player may obtain an in-game object for example by performing in-game action with the apparatus 1 which is assigned the role of that in-game object.

Another non-limiting example is a “Racing” game, which is provided to game players via embodiments of the present invention, wherein the application is a “Racing” application.

In this game, the player who first reaches predetermined physical locations, wins the game. In this game, a player may accomplish the goal of reaching a physical location for example by performing in-game action with an apparatus 1 located in that physical location.

Another non-limiting example are “Role-Playing” games, which are provided to game players via embodiments of the present invention, wherein the application is a “Role-Playing” application. Examples of Role-Playing applications include theme-based, culture-based, or civilization-based games, for example chivalry, wizardry, western, urban civilization, other civilization or culture-based games. In these games, the players are assigned roles which are associated with the predetermined theme, culture or civilization. The game rules, objectives, or in-game activities may also be associated with the predetermined theme, culture or civilization. For example, a player may win a wizardry game when the player performs predetermined magic, or obtains a predetermined role or state for example chief magician or fairy queen, or attains other objectives for example defeating predetermined in-game player or non-player characters. In this game, a player may perform magic, or obtain a role or state or attain other objectives for example by performing in-game action with other players' apparatuses or with apparatuses assigned an in-game object or non-player character role.

As another example, a player may win a chivalry game when the player performs certain deeds of courage, for example frees an in-game damsel from being held captive, or obtains a predetermined role or state for example becomes a knight, or attains other objectives for example conquers a city. In this game, a player may perform a deed of courage, or obtain a role or state or attain other objectives for example by performing in-game action with other players' apparatuses or with apparatuses assigned in-game object or non-player character role.

Another non-limiting example is a game of “Tag”, which is provided to game players via embodiments of the present invention, wherein the application is a “Tag” application. In this game, the objective of the game is that a player tags other players. A player who has been tagged becomes the tagger and is enabled to tag other players. A variant of this game is “Freeze Tag” which is played when embodiments of the current invention perform processes of a “Freeze Tag” application. In this game, a player who has been tagged is assigned a “frozen” state, but can become “unfrozen” and participate again in the game when another player other than the tagger, tags the frozen player. A player who tags all other players, wins the game. In these games, a player may accomplish the goal of tagging another player for example by performing in-game action with the other player.

Another non-limiting example is a game of “Betrayal”, which is provided to game players via embodiments of the present invention, wherein the application is a “Betrayal” application. In this game, the player who obtains a predetermined number of points first or has the highest number of points after a predetermined time, wins the game. Points can be obtained by shooting other players; in addition, a player can join a team and obtain the points from all the other team members by betraying the team, which means by shooting another member of the same team; a player can then no longer be part of the team, or join a different team. Members of a team can recover the points by shooting the betrayer within a predetermined time after the betrayal. In this game, a player may attain the objective of joining a team for example by performing in-game action with an apparatus 1 which has the in-game object role of gateway to that team. A player may attain the objective of betraying the team for example by performing in-game action with another player who is a member of the same team.

Another non-limiting example is a game of “Jailbreak”, which is provided to game players via embodiments of the present invention, wherein the application is a “Jailbreak” application. In this game, the team whose team members jail all team members of the competing team, wins the game. In this game, a player may attain the objective of jailing another player for example by performing in-game action with another player. A player may be freed from jail by a co-team member for example if the co-team member performs in-game action with an apparatus 1 assigned an in-game object role of “jail door”.

Additional variants of all of these games and other games may be played, for example by playing in teams instead of as individual players, and the team that accomplishes the objectives described for each game wins the game.

One skilled in the art will understand that a vast number and variety of games may be enabled by embodiments of the present invention, which include, but are not limited to, the example games described herein, as well as a vast number and variety of variants of games based on for example variants of game parameters for example game rules, game objectives, game roles or other game parameters.

What is claimed is:

1. An apparatus, comprising:
a central processing unit;
first wireless communication circuitry in communicative connection with said central processing unit, capable of transmitting, in response to actuation of an actuator, first data to the first wireless communication circuitry of at least one other apparatus and capable of receiving first data that is transmitted by the first wireless communication circuitry of another apparatus;
and second wireless communication circuitry in communicative connection with said central processing unit, capable of transmitting second data, in response to the first wireless communication circuitry receiving the first data, to the second wireless communication circuitry of a plurality of apparatuses and capable of receiving second data that is transmitted by the second wireless communication circuitry of any of the plurality of apparatuses,
wherein the central processing unit is configured, in response to executing an application, to perform operations comprising:
performing processes of the application by using the first data,
and performing processes of the application by using the second data.

2. The apparatus of claim 1, wherein the first data is usable for performing processes of the application comprising attaining objectives of the application, and the second data is usable for performing processes of the application comprising obtaining information representative of attained objectives of the application.

3. The apparatus of claim 1, wherein the second data comprises the first data, and wherein the first data or the second data are usable for performing processes of the application comprising attaining objectives of the application, and the second data is further usable for performing processes of the application comprising obtaining information representative of attained objectives of the application.

4. The apparatus of claim 1, wherein said central processing unit is configured, in response to executing the application, to perform operations further comprising processing an assignment of a role to said apparatus, wherein performing processes of the application by using the first data or the second data is based on at least the application and the assigned role of said apparatus.

5. The apparatus of claim 1, wherein said first wireless communication circuitry is infrared communication circuitry.

6. The apparatus of claim 1, wherein said second wireless communication circuitry is radio communication circuitry.

7. The apparatus of claim 1, wherein said second wireless communication circuitry is Wi-Fi communication circuitry.

8. The apparatus of claim 1, further comprising computer-readable memory, capable of storing the application thereon.

9. The apparatus of claim 1, further comprising video circuitry capable of outputting, in response to said apparatus performing processes of the application by using the first data or the second data, at least one graphical representation of the performed processes of the application.

10. The apparatus of claim 1, further comprising audio circuitry capable of outputting, in response to said apparatus performing processes of the application by using the first data or the second data, at least one audio representation of the performed processes of the application.

11. The apparatus of claim 1, wherein the second wireless communication circuitry is capable of transmitting the second data further via routing circuitry capable of routing second data transmission.

12. The apparatus of claim 1, wherein the second wireless communication circuitry is further capable of amplifying second data transmission.

13. The apparatus of claim 1, wherein the application is a game and the apparatus is usable for playing the game.

14. The apparatus of claim 1, further comprising a housing capable of accommodating thereon said central processing unit.

15. A computer-readable storage medium storing an application thereon, said application when executed by a central processing unit, causing said central processing unit to perform operations comprising:
receiving, via first wireless communication circuitry in communicative connection with said central processing unit, first data that is transmitted via the first wireless communication circuitry in communicative connection with another central processing unit;
receiving, via second wireless communication circuitry in communicative connection with said central processing unit, second data that is transmitted automatically via the second wireless communication circuitry in communicative connection with any of a plurality of central processing units;
performing processes of the application by using the first data or the second data to attain objectives of the application;
and performing processes of the application by using the second data to obtain information representative of attained objectives of said application.

16. The computer-readable storage medium of claim 15, wherein said first wireless communication circuitry is infrared communication circuitry.

17. The computer-readable storage medium of claim 15, wherein said second wireless communication circuitry is radio communication circuitry.

18. The computer-readable storage medium of claim 15, wherein said second wireless communication circuitry is Wi-Fi communication circuitry.

19. The computer-readable storage medium of claim 15, wherein said application when executed by said central processing unit, causes said central processing unit to perform operations further comprising assigning a role to said central processing unit, wherein the role is associated with said application, and wherein attaining objectives of said application is based on at least said application and one or both of the assigned role of said central processing unit and the assigned role of the another central processing unit.

20. The computer-readable storage medium of claim 15, wherein said application when executed by said central processing unit, causes said central processing unit to perform operations further comprising outputting, via video circuitry, at least one graphical representation of attained objectives of said application.

21. The computer-readable storage medium of claim 15, wherein said application when executed by said central processing unit, causes said central processing unit to perform operations further comprising outputting, via audio circuitry, at least one audio representation of attained objectives of said application.

22. The computer-readable storage medium of claim 15, wherein the first data is transmitted via the first wireless communication circuitry in communicative connection with the another central processing unit in response to actuation of an actuator in communicative connection with the another central processing unit.

23. The computer-readable storage medium of claim 15, wherein the second data is transmitted automatically via the second wireless communication circuitry in communicative connection with the any of a plurality of central processing units in response to the any of a plurality of central processing units receiving first data.

24. The computer-readable storage medium of claim 15, wherein a housing is capable of accommodating one or more of said computer-readable storage medium, said central processing unit, said first wireless communication circuitry and said second wireless communication circuitry.

25. The computer-readable storage medium of claim 15, wherein said computer-readable storage medium is non-volatile computer-readable storage medium.

26. A system, comprising:
first communication circuitry configured to perform first wireless communication comprising transmitting first data by a first-data-transmitting information processing device and receiving the first data by a first-data-receiving information processing device;
second communication circuitry configured to perform second wireless communication comprising transmitting second data by the first-data-receiving information processing device and receiving the second data by a plurality of information processing devices;
processing circuitry configured to cause the first communication circuitry to perform the first wireless communication and to cause the second communication circuitry to perform the second wireless communication, and further configured to perform first-data-using predetermined processes of an application by using the first data and to perform second-data-using predetermined processes of the application by using the second data.

27. The system of claim 26, wherein the first-data-using predetermined processes of the application differ from the second-data-using predetermined processes of the application.

28. The system of claim 26, wherein the first-data-using predetermined processes of the application or the second-data-using predetermined processes of the application are usable for the first-data-transmitting information processing device or the first-data-receiving information processing device to attain objectives of the application; and the second-data-using predetermined processes of the application are further usable for the plurality of information processing devices to obtain information about attained objectives of the application.

29. The system of claim 26, wherein the first communication circuitry differs from the second communication circuitry.

30. The system of claim 26, further comprising routing circuitry configured to route the second wireless communication.

31. The system of claim 26, wherein the second communication circuitry is further configured to amplify the second wireless communication.

32. The system of claim 26, further comprising audio circuitry configured to output audibly comprehensible information associated with the first-data-using predetermined processes of the application or the second-data-using predetermined processes of the application.

33. The system of claim 26, further comprising video circuitry configured to output visually comprehensible information associated with the first-data-using predetermined processes of the application or the second-data-using predetermined processes of the application.

34. The system of claim 26, further comprising computer-readable storage medium storing the application thereon.

35. A method, comprising:
providing a plurality of information processing devices, each of said information processing devices comprising first communication circuitry, second communication circuitry and processing circuitry;
transmitting, via the first communication circuitry of one of the plurality of information processing devices, first data;
receiving, via the first communication circuitry of at least one other of the plurality of information processing devices, the first data;
transmitting, via the second communication circuitry of the at least one other of the plurality of information processing device, second data, in response to receiving the first data;
receiving, via the second communication circuitry of a predetermined number of the plurality of information processing devices, the second data;
performing, by the processing circuitry, processes of an application by using the first data;
performing, by the processing circuitry, processes of the application by using the second data.

36. The method of claim 35, wherein the processes of the application performed using the first data differ from the processes of the application performed using the second data.

37. The method of claim 35, further comprising providing computer-readable storage medium storing the application thereon.

38. The method of claim 35, further comprising providing routing circuitry, wherein transmitting the second data is further via the routing circuitry.

39. The method of claim 35, further comprising providing amplification circuitry, wherein transmitting the second data is further via the amplification circuitry.

40. The method of claim 35, further comprising providing audio circuitry and outputting, via the audio circuitry, at least one representation of the performed processes of the application by using the first data or the performed processes of the application by using the second data.

41. The method of claim 35, further comprising providing video circuitry and outputting, via the video circuitry, at least one representation of the performed processes of the application by using the first data or the performed processes of the application by using the second data.

42. The method of claim 35, wherein the application is a game and the method enables a plurality of users to play the game.
